(19) United States
(12) Patent Application Publication
(10) Pub. No.: US 2019/0325585 A1
(43) Pub. Date: Oct. 24, 2019

(54) MOVEMENT INFORMATION ESTIMATION DEVICE, ABNORMALITY DETECTION DEVICE, AND ABNORMALITY DETECTION METHOD

(71) Applicant: DENSO TEN Limited, Kobe-shi (JP)

(72) Inventors: Naoshi KAKITA, Kobe-shi (JP); Kohji OHNISHI, Kobe-shi (JP); Takayuki OZASA, Kobe-shi (JP); Takeo MATSUMOTO, Kobe-shi (JP); Teruhiko KAMIBAYASHI, Kobe-shi (JP)

(73) Assignee: DENSO TEN Limited, Kobe-shi (JP)

(21) Appl. No.: 16/274,799

(22) Filed: Feb. 13, 2019

(30) Foreign Application Priority Data
Apr. 23, 2018 (JP) 2018-082274

(51) Int. Cl. G06T 7/246; G06K 9/00; G06T 7/80

(52) U.S. Cl. CPC G06T 7/246; G06T 7/80; G06K 9/00791

(57) ABSTRACT

A movement information estimation device which estimates movement information on a mobile body based on information from a camera mounted on the mobile body includes a flow deriver configured to derive an optical flow for each feature point based on an image taken by the camera and a movement information estimator configured to estimate movement information on the mobile body based on optical flows derived by the flow deriver. The movement information estimator is configured to estimate movement information on the mobile body after exclusion processing for excluding an optical flow arising from a shadow of the mobile body.

### CROSS-REFERENCES TO RELATED APPLICATIONS

This application is based upon and claims the benefit of priority from the corresponding Japanese Patent Application No. 2018-082274 filed on Apr. 23, 2018, the entire contents of which are hereby incorporated by reference.

### BACKGROUND OF THE INVENTION

### 1. Field of the Invention

The present invention relates to abnormality detection devices and abnormality detection methods, and specifically relates to the detection of abnormalities in cameras mounted on mobile bodies. The present invention also relates to the estimation of movement information on a mobile body by use of a camera mounted on the mobile body.

### 2. Description of Related Art

Conventionally, cameras are mounted on mobile bodies such as vehicles, and such cameras are used, for example, to achieve parking assistance, etc. for vehicles. For example, a vehicle-mounted camera is installed on a vehicle in a state fixed to the vehicle before the vehicle is shipped from the factory. However, due to, for example, inadvertent contact, secular change, and so forth, a vehicle-mounted camera can develop an abnormality in the form of a misalignment from the installed state at the time of factory shipment. A deviation in the installation position and the installation angle of a vehicle-mounted camera can cause an error in the judgement on the amount of steering and the like made by use of images taken by the camera, and this makes it important to detect an installation misalignment of the vehicle-mounted camera.

JP-A-2004-338637 discloses a vehicle travel assistance device that includes a first movement-amount calculation means which calculates the amount of movement of a vehicle, regardless of a vehicle state amount, by subjecting an image obtained by a rear camera to image processing performed by an image processor and a second movement-amount calculation means which calculates the amount of movement of the vehicle based on the vehicle state amount on the basis of the outputs of a wheel speed sensor and a steering angle sensor. For example, the first movement-amount calculation means extracts a feature point from image data obtained by the rear camera by means of edge extraction, for example, then calculates the position of the feature point on the ground surface set by means of inverse projective transformation, and calculates the amount of movement of the vehicle based on the amount of movement of the position. JP-A-2004-338637 discloses that when, as a result of comparison between the amounts of movement calculated by the first and second movement-amount calculation means, if a large deviation is found between the amounts of movement of the vehicle, then it is likely that a problem has occurred in either one of the first and second movement-amount calculation means.

### SUMMARY OF THE INVENTION

In a case where the shadow of a mobile body is present in images taken by a camera, at the border position of the shadow, etc., for example, a feature point is detected the amount of movement of which between two images taken in a short period of time is zero despite that the mobile body has actually moved (see, for example, JP-A-2015-200976). With this configuration, when the shadow of a mobile body is present in images taken by the camera, if the amount of movement of the mobile body is estimated by using the movement of the feature point included in the image data, the estimated value of the amount of movement may be inaccurate. A determination made by using the thus estimated value on whether the camera is operating properly may be an erroneous determination.

An object of the present invention is to provide a technology that permits proper detection of abnormalities in a camera mounted on a mobile body.

A movement information estimation device illustrative of the present invention is one that estimates movement information on a mobile body based on information from a camera mounted on the mobile body, and includes a flow deriver configured to derive an optical flow for each feature point based on an image taken by the camera, and a movement information estimator configured to estimate movement information on the mobile body based on optical flows derived by the flow deriver. Here, the movement information estimator is configured to judge whether or not an optical flow arising from a shadow of the mobile body is included in the optical flows derived by the flow deriver, and to estimate movement information on the mobile body after performing exclusion processing for excluding the optical flow arising from the shadow of the mobile body, when the optical flow arising from the shadow of the mobile body is included in the optical flows derived by the flow deriver.

An abnormality detection device illustrative of the present invention is one that detects an abnormality in a camera mounted on a mobile body, and includes a flow deriver configured to derive an optical flow for each feature point, based on an image taken by the camera, a movement information estimator configured to estimate first movement information on the mobile body based on optical flows derived by the flow deriver, a movement information acquirer configured to acquire second movement information on the mobile body, the second movement information being a target of comparison with the first movement information, and an abnormality determiner configured to determine an abnormality in the camera based on the first movement information and the second movement information. Here, the movement information estimator is configured to estimate the first movement information after performing exclusion processing for excluding an optical flow a magnitude of which can be regarded as zero when an amount of the optical flow the magnitude of which can be regarded as zero is equal to or less than a predetermined amount.

### BRIEF DESCRIPTION OF THE DRAWINGS

FIG. 1 is a block diagram showing a configuration of an abnormality detection system.

FIG. 2 is a diagram illustrating positions at which vehicle-mounted cameras are disposed in a vehicle.

FIG. 3 is a flow chart showing an example of a procedure for the detection of a camera misalignment performed by an abnormality detection device.

FIG. 4 is a diagram for illustrating a method for extracting feature points.

FIG. 5 is a diagram for illustrating a method for deriving a first optical flow.

FIG. 6 is a diagram for illustrating coordinate conversion processing.

FIG. 7 is a diagram showing an example of a first histogram generated by a movement information estimator.

FIG. 8 is a diagram showing an example of a second histogram generated by a movement information estimator.

FIG. 9 is a diagram illustrating a change caused in a histogram by a camera misalignment.

FIG. 10 is a flow chart showing an example of camera misalignment determination processing performed by an abnormality determiner.

FIG. 11 is a schematic diagram illustrating a taken image taken by a front camera.

FIG. 12 is a diagram showing a first histogram generated based on the taken image shown in FIG. 11.

FIG. 13 is a schematic diagram illustrating a taken image taken by a front camera in which a large camera misalignment has occurred.

FIG. 14 is a diagram showing a first histogram generated based on the taken image shown in FIG. 13.

FIG. 15 is a diagram for illustrating a method for determining a predetermined amount to be used for determining whether or not to perform exclusion processing.

FIG. 16 is a flow chart showing an example of procedure for determining whether or not to perform the exclusion processing.

FIG. 17 is a schematic diagram for illustrating a histogram generated in a case where the exclusion processing is performed.

FIG. 18 is a schematic diagram for illustrating a histogram generated in a case where the exclusion processing is not performed.

FIG. 19 is a block diagram showing a configuration of an abnormality detection device according to a first modified example.

FIG. 20 is a schematic diagram for illustrating an abnormality detection device according to a second modified example.

### DETAILED DESCRIPTION OF PREFERRED EMBODIMENTS

Hereinafter, illustrative embodiments of the present invention will be described in detail with reference to the accompanying drawings. Although the following description deals with a vehicle as an example of a mobile body, this is not meant as any limitation to vehicles. Vehicles include a wide variety of wheeled vehicle types, including automobiles, trains, automated guided vehicles, and so forth. Mobile bodies other than vehicles include, for example, ships, airplanes, and so forth.

The different directions mentioned in the following description are defined as follows. The direction which runs along the vehicle's straight traveling direction and which points from the driver's seat to the steering wheel is referred to as the “front” direction. The direction which runs along the vehicle's straight traveling direction and which points from the steering wheel to the driver's seat is referred to as the “rear” direction. The direction which runs perpendicularly to both the vehicle's straight traveling direction and the vertical line and which points from the right side to the left side of the driver facing frontward is referred to as the “left” direction. The direction which runs perpendicularly to both the vehicle's straight traveling direction and the vertical line and which points from the left side to the right side of the driver facing frontward is referred to as the “right” direction.

### 1. Abnormality Detection System

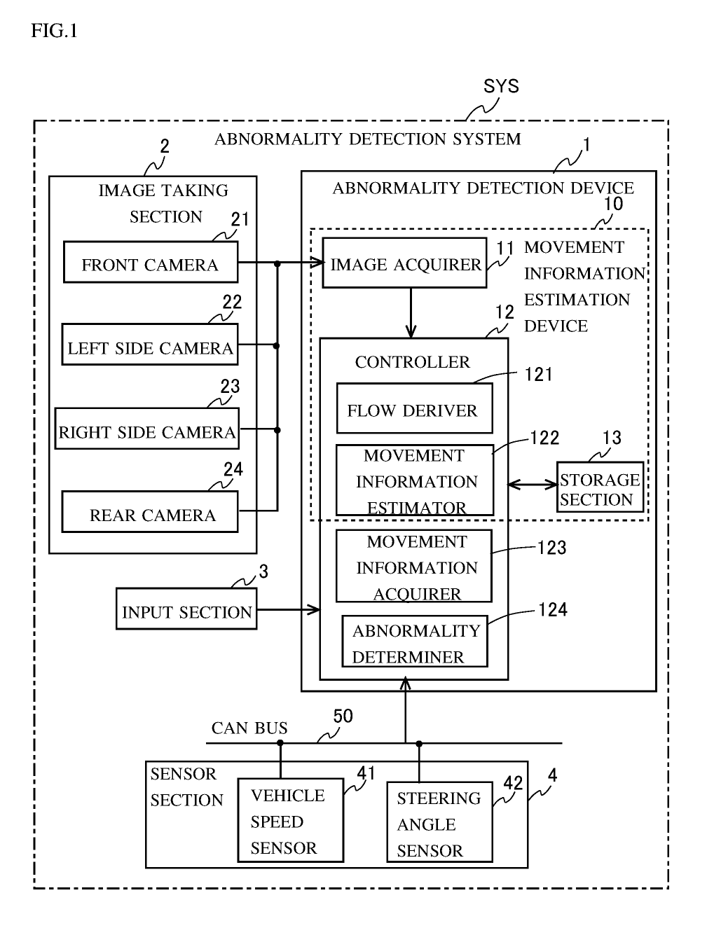

FIG. 1 is a block diagram showing a configuration of an abnormality detection system SYS according to an embodiment of the present invention. In this embodiment, an abnormality is defined as a state where a misalignment has developed in the installation of a camera. That is, the abnormality detection system SYS is a system that detects a misalignment in how a camera mounted on a vehicle is installed. More specifically, the abnormality detection system SYS is a system for detecting an abnormality such as a misalignment of a camera mounted on a vehicle from its reference installed state such as its installed state at the time of factory shipment of the vehicle. As shown in FIG. 1, the abnormality detection system SYS includes an abnormality detection device 1, an image taking section 2, an input section 3, and a sensor section 4.

The abnormality detection device 1 is a device for detecting abnormalities in cameras mounted on a vehicle. More specifically, the abnormality detection device 1 is a device for detecting an installation misalignment in how the cameras are installed on the vehicle. The installation misalignment includes deviations in the installation position and angle of the cameras. By using the abnormality detection device 1, it is possible to promptly detect a misalignment in how the cameras mounted on the vehicle are installed, and thus to prevent driving assistance and the like from being performed with a camera misalignment. Hereinafter, a camera mounted on a vehicle may be referred to as “vehicle-mounted camera”. Here, as shown in FIG. 1, the abnormality detection device 1 includes a movement information estimation device 10 which estimates movement information on a vehicle based on information from cameras mounted on the vehicle.

The abnormality detection device 1 is provided on each vehicle furnished with vehicle-mounted cameras. The abnormality detection device 1 processes images taken by vehicle-mounted cameras 21 to 24 included in the image taking section 2 and information from the sensor section 4 provided outside the abnormality detection device 1, and thereby detects deviations in the installation position and the installation angle of the vehicle-mounted cameras 21 to 24. The abnormality detection device 1 will be described in detail later.

Here, the abnormality detection device 1 may output the processed information to a display device, a driving assisting device, or the like, of which none is illustrated. The display device may display, on a screen, warnings and the like, as necessary, based on the information fed from the abnormality detection device 1. The driving assisting device may halt a driving assisting function, or correct taken-image information to perform driving assistance, as necessary, based on the information fed from the abnormality detection device 1. The driving assisting device may be, for example, a device that assists automatic driving, a device that assists automatic parking, a device that assists emergency braking, etc.

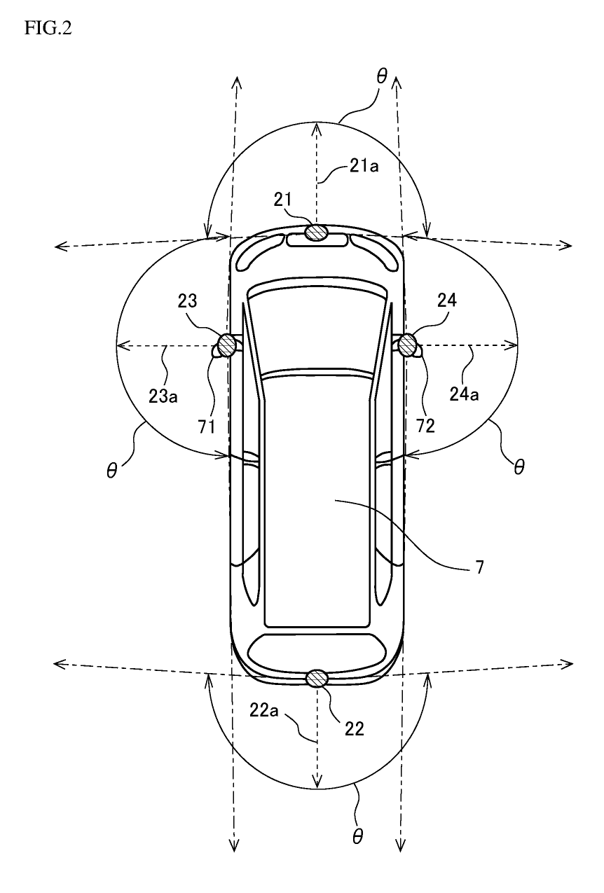

The image taking section 2 is provided on the vehicle for the purpose of monitoring the circumstances around the vehicle. In this embodiment, the image taking section 2 includes the four vehicle-mounted cameras 21 to 24. The vehicle-mounted cameras 21 to 24 are each connected to the abnormality detection device 1 on a wired or wireless basis. FIG. 2 is a diagram showing an example of the positions at which the vehicle-mounted cameras 21 to 24 are respectively disposed on a vehicle 7. FIG. 2 is a view of the vehicle 7 as seen from above. The vehicle illustrated in FIG. 2 is an automobile.

The vehicle-mounted camera 21 is provided at the front end of the vehicle 7. Accordingly, the vehicle-mounted camera 21 is referred to also as a front camera 21. The optical axis 21a of the front camera 21 runs along the front-rear direction of the vehicle 7. The front camera 21 takes an image frontward of the vehicle 7. The vehicle-mounted camera 22 is provided at the rear end of the vehicle 7. Accordingly, the vehicle-mounted camera 22 is referred to also as a rear camera 22. The optical axis 22a of the rear camera 22 runs along the front-rear direction of the vehicle 7. The rear camera 22 takes an image rearward of the vehicle 7. The installation positions of the front and rear cameras 21 and 22 are preferably at the center in the left-right direction of the vehicle 7, but can instead be positions slightly deviated from the center in the left-right direction.

The vehicle-mounted camera 23 is provided on a left-side door mirror 71 of the vehicle 7. Accordingly, the vehicle-mounted camera 23 is referred to also as a left side camera 23. The optical axis 23a of the left side camera 23 runs along the left-right direction of the vehicle 7. The left side camera 23 takes an image leftward of the vehicle 7. The vehicle-mounted camera 24 is provided on a right-side door mirror 72 of the vehicle 7. Accordingly, the vehicle-mounted camera 24 is referred to also as a right side camera 24. The optical axis 24a of the right side camera 24 runs along the left-right direction of the vehicle 7. The right side camera 24 takes an image rightward of the vehicle 7.

The vehicle-mounted cameras 21 to 24 all include fish-eye lenses with an angle of view of 180° or more in the horizontal direction. Thus, the vehicle-mounted cameras 21 to 24 can together take an image all around the vehicle 7 in the horizontal direction. Although, in this embodiment, the number of vehicle-mounted cameras is four, the number can be changed as necessary; there can be provided a plurality of vehicle-mounted cameras or a single vehicle-mounted camera. For example, in a case where the vehicle 7 is furnished with vehicle-mounted cameras for the purpose of assisting reverse parking of the vehicle 7, the image taking section 2 may include three vehicle-mounted cameras, namely, the rear camera 22, the left side camera 23, and the right side camera 24.

With reference back to FIG. 1, the input section 3 is configured to accept instructions to the abnormality detection device 1. The input section 3 may include, for example, a touch screen, buttons, levers, and so forth. The input section 3 is connected to the abnormality detection device 1 on a wired or wireless basis.

The sensor section 4 includes a plurality of sensors that detect information on the vehicle 7 furnished with the vehicle-mounted cameras 21 to 24. In this embodiment, the sensor section 4 includes a vehicle speed sensor 41 and a steering angle sensor 42. The vehicle speed sensor 41 detects the speed of the vehicle 7. The steering angle sensor 42 detects the rotation angle of the steering wheel of the vehicle 7. The vehicle speed sensor 41 and the steering angle sensor 42 are connected to the abnormality detection device 1 via a communication bus 50. Thus, the information on the speed of the vehicle 7 that is acquired by the vehicle speed sensor 41 is fed to the camera misalignment detection device 1 via the communication bus 50. The information on the rotation angle of the steering wheel of the vehicle 7 that is acquired by the steering angle sensor 42 is fed to the abnormality detection device 1 via the communication bus 50. The communication bus 50 may be, for example, a CAN (Controller Area Network) bus.

### 2. Abnormality Detection Device

### 2-1. Outline of Abnormality Detection Device

As shown in FIG. 1, the abnormality detection device 1 includes an image acquirer 11, a controller 12, and a storage section 13.

The image acquirer 11 acquires images from each of the four vehicle-mounted cameras 21 to 24. The image acquirer 11 has basic image processing functions such as an analog-to-digital conversion function for converting analog taken images into digital taken images. The image acquirer 11 subjects the acquired taken images to predetermined image processing, and feeds the processed taken images to the controller 12.

The controller 12 is a microcomputer, for example, and controls the entire abnormality detection device 1 in a concentrated fashion. The controller 12 includes a CPU, a RAM, a ROM, etc. The storage section 13 is, for example, a non-volatile memory such as a flash memory, and stores various kinds of information. The storage section 13 stores programs as firmware and various kinds of data.

More specifically, the controller 12 includes a flow deriver 121, a movement information estimator 122, a movement information acquirer 123, and an abnormality determiner 124. That is, the abnormality detection device 1 includes the deriver 121, the movement information estimator 122, the movement information acquirer 123, and the abnormality determiner 124. The functions of these portions 121 to 124 provided in the controller 12 are achieved, for example, through operational processing by the CPU according to the programs stored in the storage section 13.

At least one of the flow deriver 121, the movement information estimator 122, the movement information acquirer 123, and the abnormality determiner 124 in the controller 12 can be configured in hardware such as an ASIC (application-specific integrated circuit) or an FPGA (field-programmable gate array). The flow deriver 121, the movement information estimator 122, the movement information acquirer 123, and the abnormality determiner 124 are conceptual constituent elements; the functions carried out by any one of them may be distributed among a plurality of constituent elements, or the functions of a plurality of constituent elements may be integrated into a single constituent element. The image acquirer 11 may be achieved by the CPU in the controller 12 performing calculation processing according to a program.

The flow deriver 121 derives an optical flow for each feature point for each of the vehicle-mounted cameras 21 to 24. A feature point is an outstandingly detectable point in a taken image, such as an intersection between edges in a taken image. A feature point is, for example, an edge of a white line drawn on the road surface, a crack in the road surface, a speck on the road surface, a piece of gravel on the road surface, or the like. Usually, there are a number of feature points in one taken image. The flow deriver 121 derives feature points in taken images by a well-known method such as the Harris operator.

An optical flow is a motion vector representing the movement of a feature point between two images taken at a predetermined time interval from each other. In this embodiment, optical flows derived by the flow deriver 121 include first optical flows and second optical flows. First optical flows are optical flows acquired from images (images themselves) taken by the cameras 21 to 24. Second optical flows are optical flows acquired by subjecting the first optical flows to coordinate conversion. Herein, such a first optical flow OF1 and a second optical flow OF2 as are derived from the same feature point will sometimes be referred to simply as an optical flow when there is no need of making a distinction between them.

In this embodiment, the vehicle 7 is furnished with four vehicle-mounted cameras 21 to 24. Accordingly, the flow deriver 121 derives an optical flow for each feature point for each of the vehicle-mounted cameras 21 to 24. The flow deriver 121 may be configured to directly derive optical flows corresponding to the second optical flows mentioned above by subjecting, to coordinate conversion, the feature points extracted from images taken by the cameras 21 to 24. In this case, the flow deriver 121 does not derive the first optical flows described above, but derives only one kind of optical flows.

The movement information estimator 122 estimates first movement information on the vehicle 7 based on optical flows. In this embodiment, the movement information estimator 122 performs statistical processing on a plurality of second optical flows to estimate the first movement information. In this embodiment, since the vehicle 7 is furnished with the four vehicle-mounted cameras 21 to 24, the movement information estimator 122 estimates the first movement information on the vehicle 7 for each of the vehicle-mounted cameras 21 to 24. The statistical processing performed by the movement information estimator 122 is processing performed by using histograms. The histogram-based processing for estimating the first movement information will be described in detail later.

In this embodiment, the first movement information is information on the movement distance of the vehicle 7. The first movement information may be, however, information on a factor other than the movement distance. The first movement information may be information on, for example, the speed (vehicle speed) of the vehicle 7.

The movement information acquirer 123 acquires second movement information on the vehicle 7 as a target of comparison with the first movement information. In this embodiment, the movement information acquirer 123 acquires the second movement information based on information obtained from a sensor other than the cameras 21 to 24 provided on the vehicle 7. Specifically, the movement information acquirer 123 acquires the second movement information based on information obtained from the sensor section 4. In this embodiment, since the first movement information is information on the movement distance, the second movement information, which is to be compared with the first movement information, is also information on the movement distance. The movement information acquirer 123 acquires the movement distance by multiplying the vehicle speed obtained from the vehicle speed sensor 41 by a predetermined time. According to this embodiment, it is possible to detect a camera misalignment by using a sensor generally provided on the vehicle 7, and this helps reduce the cost of equipment required to achieve camera misalignment detection.

In a case where the first movement information is information on the vehicle speed instead of the movement distance, the second movement information is also information on the vehicle speed. The movement information acquirer 123 may acquire the second movement information based on information acquired from a GPS (Global Positioning System) receiver, instead of from the vehicle speed sensor 41. The movement information acquirer 123 may be configured to acquire the second movement information based on information obtained from at least one of the vehicle-mounted cameras excluding one that is to be the target of camera-misalignment detection. In this case, the movement information acquirer 123 may acquire the second movement information based on optical flows obtained from the vehicle-mounted cameras other than the one that is to be the target of camera-misalignment detection.

The abnormality determiner 124 determines abnormalities in the cameras 21 to 24 based on the first movement information and the second movement information. In this embodiment, the abnormality determiner 124 uses the movement distance, obtained as the second movement information, as a correct value, and determines the deviation, with respect to the correct value, of the movement distance obtained as the first movement information. When the deviation is above a predetermined threshold value, the abnormality determiner 124 detects a camera misalignment. In this embodiment, since the vehicle 7 is furnished with the four vehicle-mounted cameras 21 to 24, the abnormality determiner 124 determines an abnormality for each of the vehicle-mounted cameras 21 to 24.

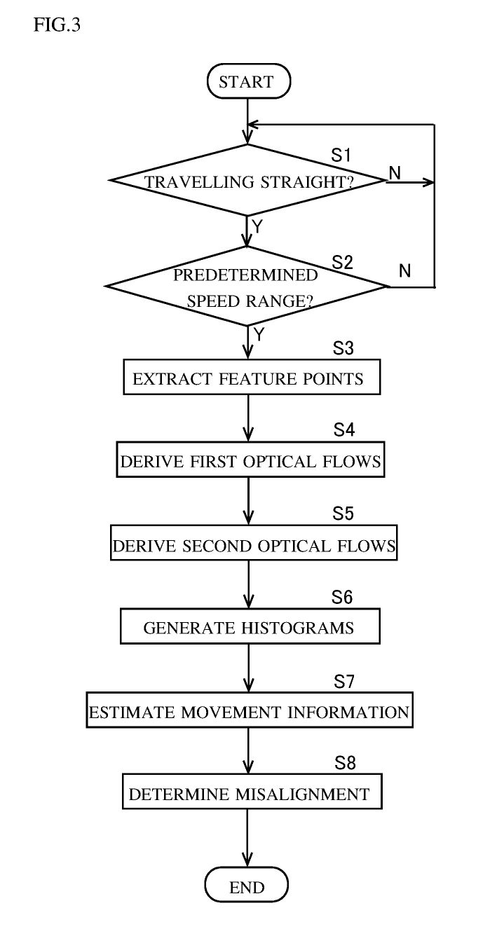

FIG. 3 is a flow chart showing an example of a procedure for the detection of a camera misalignment performed by the abnormality detection device 1. In this embodiment, the camera misalignment detection procedure shown in FIG. 3 is performed for each of the four vehicle-mounted cameras 21 to 24. Here, to avoid overlapping description, the camera misalignment detection procedure will be described with respect to the front camera 21 as a representative.

As shown in FIG. 3, first, the controller 12 monitors whether or not the vehicle 7 furnished with the front camera 21 is traveling straight (step S1). Whether or not the vehicle 7 is traveling straight can be judged, for example, based on the rotation angle information on the steering wheel, which is obtained from the steering angle sensor 42. For example, assuming that the vehicle 7 travels completely straight when the rotation angle of the steering wheel equals zero, then, not only when the rotation angle equals zero but also when it falls within a certain range in the positive and negative directions, the vehicle 7 may be judged to be traveling straight. Straight traveling includes both forward straight traveling and backward straight traveling.

The controller 12 repeats the monitoring in step 51 until straight traveling of the vehicle 7 is detected. Unless the vehicle 7 travels straight, no information for determining a camera misalignment is acquired. With this configuration, no determination of a camera misalignment is performed by use of information acquired when the vehicle 7 is traveling along a curved path; this helps avoid complicating the information processing for the determination of a camera misalignment.

If the vehicle 7 is judged to be traveling straight (Yes in step S1), the controller 12 checks whether or not the speed of the vehicle 7 is within a predetermined speed range (step S2). The predetermined speed range may be, for example, 3 km per hour or higher but 5 km per hour or lower. In this embodiment, the speed of the vehicle 7 can be acquired by means of the vehicle speed sensor 41. Steps S1 and S2 can be reversed in order. Steps S1 and S2 can be performed concurrently.

If the speed of the vehicle 7 is outside the predetermined speed range (No in step S2), then, back in step S1, the controller 12 makes a judgment on whether or not the vehicle 7 is traveling straight. That is, in this embodiment, unless the speed of the vehicle 7 is within the predetermined speed range, no information for determining a camera misalignment is acquired. For example, if the speed of the vehicle 7 is too high, errors are apt to occur in the derivation of optical flows. On the other hand, if the speed of the vehicle 7 is too low, the reliability of the speed of the vehicle 7 acquired from the vehicle speed sensor 41 is reduced. In this respect, with the configuration according to this embodiment, a camera misalignment is determined except when the speed of the vehicle 7 is too high or too low, and this helps enhance the reliability of camera misalignment determination.

It is preferable that the predetermined speed range be variably set. With this configuration, the predetermined speed range can be adapted to cover values that suit individual vehicles, and this helps enhance the reliability of camera misalignment determination. In this embodiment, the predetermined speed range can be set via the input section 3.

When the vehicle 7 is judged to be traveling within the predetermined speed range (Yes in step S2), the flow deriver 121 extracts a feature point (step S3). It is preferable that the extraction of a feature point by the flow deriver 121 be performed when the vehicle 7 is traveling stably within the predetermined speed range.

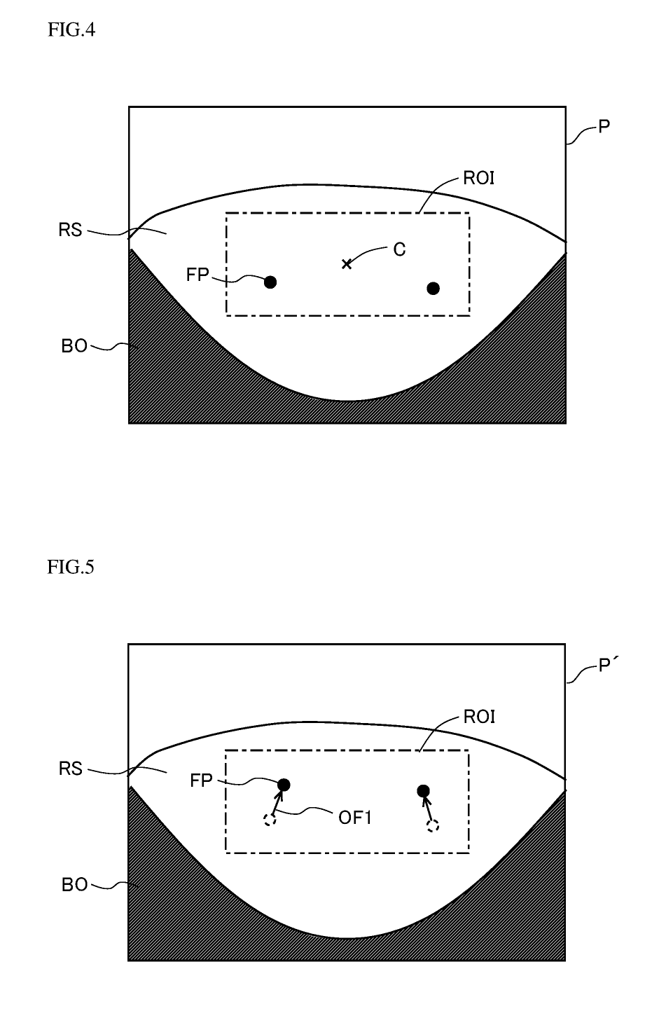

FIG. 4 is a diagram for illustrating a method for extracting feature points FP. FIG. 4 schematically shows a taken image P that is taken by the front camera 21. The feature points FP exist on the road surface RS. In FIG. 4, two feature points FP are shown, but the number here is set merely for convenience of description, and does not indicate the number of actually extracted feature points FP. Usually, a large number of feature points FP are acquired.

As shown in FIG. 4, the flow deriver 121 extracts feature points FP within a predetermined region (hereinafter referred to as ROI (Region Of Interest)) in the taken image P. In other words, feature point FP are extracted from within the predetermined region (ROI) of the image taken by the camera 21. The ROI is set to be a wide range including the center C of the taken image P. Thus, it is possible to extract feature points FP even in cases where they appear at unevenly distributed spots, in a lopsided range. The ROI is set excluding a region where a body BO of the vehicle 7 shows.

When feature points FP are extracted, the flow deriver 121 derives a first optical flow for each of the extracted feature points FP (step S4). FIG. 5 is a diagram for illustrating a method for deriving a first optical flow OF1. FIG. 5, like FIG. 4, is a schematic diagram illustrated for convenience of description. What FIG. 5 shows is the taken image (current frame P′) that is taken by the front camera 21 a predetermined period after the taking of the taken image (previous frame P) shown in FIG. 4. After the taking of the taken image P shown in FIG. 4, by the time that the predetermined period expires, the vehicle 7 has reversed. The broken-line circles in FIG. 5 indicate the positions of the feature points FP at the time of the taking of the taken image P shown in FIG. 4.

As shown in FIG. 5, as the vehicle 7 reverses, the feature points FP located ahead of the vehicle 7 move away from the vehicle 7. That is, the positions at which the feature points FP appear are different between in the current frame P′ and in the previous frame P. The flow deriver 121 associates the feature points FP in the current frame P′ with the feature points FP in the previous frame P based on pixel values nearby, and derives first optical flows OF1 based on the respective positions of the feature points FP thus associated with each other.

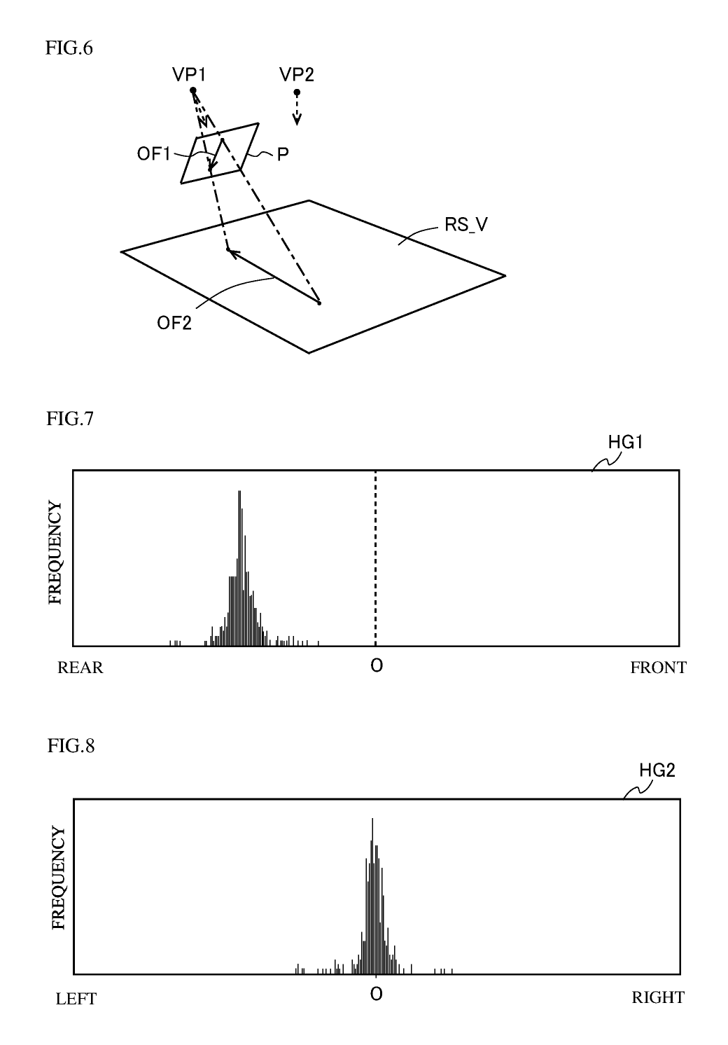

When the first optical flows OF1 are derived, the flow deriver 121 performs coordinate conversion on the first optical flows OF1, which have been obtained in the camera coordinate system, and thereby derives second optical flows OF2 in the world coordinate system (step S5). FIG. 6 is a diagram for illustrating the coordinate conversion processing. As shown in FIG. 6, the flow deriver 121 converts a first optical flow OF1 as seen from the position (view point VP1) of the front camera 21 into a second optical flow OF2 as seen from a view point VP2 above the road surface which the vehicle 7 is on. The flow deriver 121 converts each first optical flow OF1 in the taken image P into a second optical flow OF2 in the world coordinate system by projecting the former on a virtual plane RS_ V that corresponds to the road surface. The second optical flow OF2 is a movement vector of the vehicle 7 on a road surface RS, and its magnitude indicates the amount of movement of the vehicle 7 on the road surface.

Next, the movement information estimator 122 generates a histogram based on the plurality of second optical flows OF2 derived by the flow deriver 121 (step S6). In this embodiment, the movement information estimator 122 divides each second optical flow OF2 into two, front-rear and left-right, components, and generates a first histogram and a second histogram. FIG. 7 is a diagram showing an example of the first histogram HG1 generated by the movement information estimator 122. FIG. 8 is a diagram showing an example of the second histogram HG2 generated by the movement information estimator 122. FIGS. 7 and 8 show histograms that are obtained when no camera misalignment is present.

The first histogram HG1 shown in FIG. 7 is a histogram obtained based on the front-rear component of each of the second optical flows OF2. The first histogram HG1 is a histogram where the number of second optical flows OF2 is taken along the frequency axis and the movement distance in the front-rear direction (the length of the front-rear component of each of the second optical flows OF2) is taken along the class axis. The second histogram HG2 shown in FIG. 8 is a histogram obtained based on the left-right component of each of the second optical flows OF2. The second histogram HG2 is a histogram where the number of second optical flows OF2 is taken along the frequency axis and the movement distance in the left-right direction (the length of the left-right component of each of the second optical flows OF2) is taken along the class axis.

FIGS. 7 and 8 show histograms obtained when, while no camera misalignment is present, the vehicle 7 has traveled straight backward at a speed within the predetermined speed range. Accordingly, the first histogram HG1 has a normal distribution shape in which the frequency is high lopsidedly around a particular movement distance (class) on the rear side. On the other hand, the second histogram HG2 has a normal distribution shape in which the frequency is high lopsidedly around a class near zero of the movement distance.

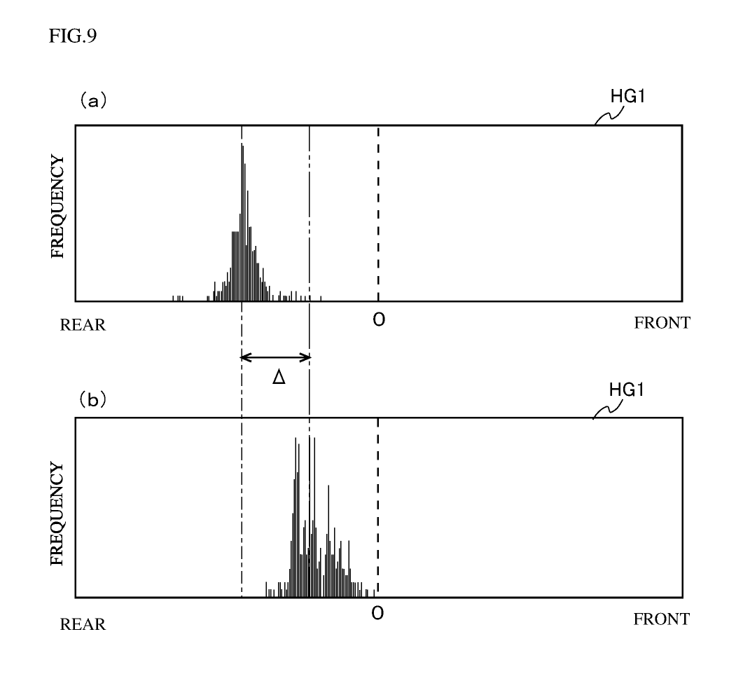

FIG. 9 is a diagram illustrating a change caused in a histogram by a camera misalignment. FIG. 9 illustrates a case where the front camera 21 is misaligned as a result of rotation in the tilt direction (vertical direction). In FIG. 9, in the upper tier (a) is the first histogram HG1 obtained with no camera misalignment present (in the normal condition), and in the lower tier (b) is the first histogram HG1 obtained with a camera misalignment present. A misalignment of the front camera 21 resulting from rotation in the tilt direction has an effect chiefly on the front-rear component of a second optical flow OF2. In the example shown in FIG. 9, the misalignment of the front camera 21 resulting form rotation in the tilt direction causes the classes where the frequency is high to be displaced frontward as compared with in the normal condition.

A misalignment of the front camera 21 resulting from rotation in the tilt direction has only a slight effect on the left-right component of a second optical flow OF2. Accordingly, though not illustrated, the change of the second histogram HG2 without and with a camera misalignment is smaller than that of the first histogram HG1. This, however, is the case when the front camera 21 is misaligned in the tilt direction; if the front camera 21 is misaligned, for example, in a pan direction (horizontal direction) or in a roll direction (the direction of rotation about the optical axis), the histograms change in a different fashion.

Based on the generated histograms HG1 and HG2, the movement information estimator 122 estimates the first movement information on the vehicle 7 (step S7). In this embodiment, the movement information estimator 122 estimates the movement distance of the vehicle 7 in the front-rear direction based on the first histogram HG1; the movement information estimator 122 estimates the movement distance of the vehicle 7 in the left-right direction based on the second histogram HG2. That is, the movement information estimator 122 estimates, as the first movement information, the movement distances of the vehicle 7 in the front-rear and left-right directions. With this configuration, it is possible to detect a camera misalignment by use of estimated values of the movement distances of the vehicle 7 in the front-rear and left-right directions, and it is thus possible to enhance the reliability of the result of camera misalignment detection.

In this embodiment, the movement information estimator 122 takes the middle value (median) of the first histogram HG1 as the estimated value of the movement distance in the front-rear direction; the movement information estimator 122 takes the middle value of the second histogram HG2 as the estimated value of the movement distance in the left-rear direction. This, however, is not meant to limit the method by which the movement information estimator 122 determines the estimated values. For example, the movement information estimator 122 may take the movement distances of the classes where the frequencies in the histograms HG1 and HG2 are respectively maximum as the estimated values of the movement distances. For another example, the movement information estimator 122 may take the average values in the respective histograms HG1 and HG2 as the estimated values of the movement distances.

In the example shown in FIG. 9, a dash-dot line indicates the estimated value of the movement distance in the front-rear direction when the front camera 21 is in the normal condition, and a dash-dot-dot line indicates the estimated value of the movement distance in the front-rear direction when a camera misalignment is present. As shown in FIG. 9, a camera misalignment produces a difference Δ in the estimated value of the movement distance in the front-rear direction.

When estimated values of the first movement information on the vehicle 7 are obtained by the movement information estimator 122, the abnormality determiner 124 determines a misalignment of the front camera 21 by comparing the estimated values with second movement information acquired by the movement information acquirer 123 (step S8).

The movement information acquirer 123 acquires, as the second movement information, the movement distances of the vehicle 7 in the front-rear and left-right directions. In this embodiment, the movement information acquirer 123 acquires the movement distances of the vehicle 7 in the front-rear and left-right directions based on information obtained from the sensor section 4. There is no particular limitation to the timing with which the movement information acquirer 123 acquires the second information; for example, the movement information acquirer 123 may perform the processing for acquiring the second information concurrently with the processing for estimating the first movement information performed by the movement information estimator 122.

In this embodiment, misalignment determination is performed based on information obtained when the vehicle 7 is traveling straight in the front-rear direction. Accordingly, the movement distance in the left-right direction acquired by the movement information acquirer 123 equals zero. The movement information acquirer 123 calculates the movement distance in the front-rear direction based on the image taking time interval between the two taken images for the derivation of optical flows and the speed of the vehicle 7 during that interval that is obtained by the vehicle speed sensor 41.

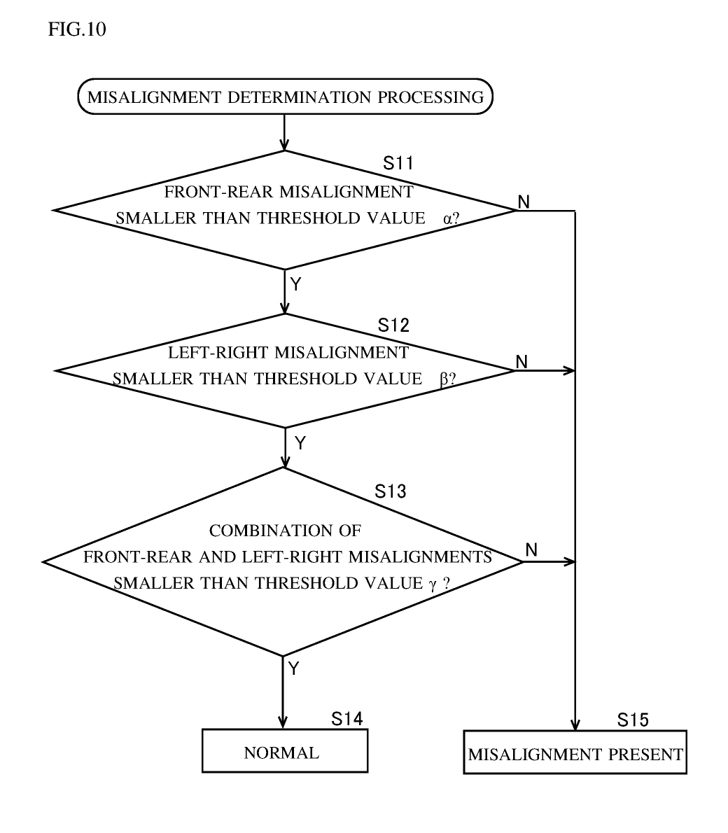

FIG. 10 is a flow chart showing an example of the camera misalignment determination processing performed by the abnormality determiner 124. First, for the movement distance of the vehicle 7 in the front-rear direction, the abnormality determiner 124 checks whether or not the difference between the estimated value calculated by the movement information estimator 122 and the acquired value acquired by the movement information acquirer 123 is smaller than a threshold value α (step S11). When the difference between the two values is equal to or larger than the threshold value α (No in Step S11), the abnormality determiner 124 determines that the front camera 21 is installed in an abnormal state and is misaligned (step S15). On the other hand, if the difference between the two values is smaller than the threshold value α (Yes in Step S11), the abnormality determiner 124 determines that no abnormality is detected from the movement distance of the vehicle 7 in the front-rear direction.

When no abnormality is detected based on the movement distance of the vehicle 7 in the front-rear direction (Yes in step S11), then the abnormality determiner 124, for the movement distance of the vehicle 7 in the left-right direction, checks whether or not the difference between the estimated value calculated by the estimator 122 and the acquired value acquired by the movement information acquirer 123 is smaller than a threshold value β (step S12). When the difference between the two values is equal to or larger than the threshold value β (No in step S12), the abnormality determiner 124 determines that the front camera 21 is installed in an abnormal state and is misaligned (step S15). On the other hand, if the difference between the two values is smaller than the threshold value β (Yes in step S12), the abnormality determiner 124 determines that no abnormality is detected based on the movement distance in the left-right direction.

When no abnormality is detected based on the movement distance of the vehicle 7 in the left-right direction either, then the abnormality determiner 124, for particular values obtained based on the movement distances in the front-rear and left-right directions, checks whether or not the difference between the particular value obtained from the first movement information and the particular value obtained from the second movement information is smaller than a threshold value γ (step S13). In this embodiment, a particular value is a value of the square root of the sum of the value obtained by squaring the movement distance of the vehicle 7 in the front-rear direction and the value obtained by squaring the movement distance of the vehicle 7 in the left-right direction. This, however, is merely an example; a particular value may instead be, for example, the sum of the value obtained by squaring the movement distance of the vehicle 7 in the front-rear direction and the value obtained by squaring the movement distance of the vehicle 7 in the left-right direction.

When the difference between the particular value obtained from the first movement information and the particular value obtained from the second movement information is equal to or larger than the threshold value γ (No in step S13), the abnormality determiner 124 determines that the front camera 21 is installed in an abnormal state and is misaligned (step S15). On the other hand, when the difference between the two values is smaller than the threshold value γ (Yes in step S13), the abnormality determiner 124 determines that the front camera 21 is installed in a normal state (step S14).

In this embodiment, when an abnormality is recognized in any one of the movement distance of the vehicle 7 in the front-rear direction, the movement distance of the vehicle 7 in the left-right direction, and the particular value, it is determined that a camera misalignment is present. With this configuration, it is possible to make it less likely to determine that no camera misalignment is present despite one being present. This, however, is merely an example; for example, a configuration is also possible where, only if an abnormality is recognized in all of the movement distance of the vehicle 7 in the front-rear direction, the movement distance of the vehicle 7 in the left-right direction, and the particular value, it is determined that a camera misalignment is present. It is preferable that the criteria for the determination of a camera misalignment be changeable as necessary via the input section 3.

In this embodiment, for the movement distance of the vehicle 7 in the front-rear direction, the movement distance of the vehicle 7 in the left-right direction, and the particular value, comparison is performed by turns; instead, their comparison may be performed concurrently. In a configuration where, for the movement distance of the vehicle 7 in the front-rear direction, the movement distance of the vehicle 7 in the left-right direction, and the particular value, comparison is performed by turns, there is no particular restriction on the order; the order may be different from that shown in FIG. 10. In this embodiment, misalignment determination is performed based on the movement distance of the vehicle 7 in the front-rear direction, the movement distance of the vehicle 7 in the left-right direction, and the particular value, but this is merely an example. Instead, for example, misalignment determination may be performed based on any one or two of the movement distance of the vehicle 7 in the front-rear direction, the movement distance of the vehicle 7 in the left-right direction, and the particular value.

In this embodiment, misalignment determination is performed each time the first movement information is obtained by the movement information estimator 122, but this also is merely an example. Instead, camera misalignment determination may be performed after the processing for estimating the first movement information is performed by the movement information estimator 122 a plurality of times. For example, at the time point when the estimation processing for estimating the first movement information has been performed a predetermined number of times by the movement information estimator 122, the abnormality determiner 124 may perform misalignment determination by use of a cumulative value, which is obtained by accumulating the first movement information (movement distances) acquired through the estimation processing performed the predetermined number of times. Here, what is compared with the cumulative value of the first movement information is a cumulative value of the second movement information obtained as the target of comparison with the first movement information acquired through the estimation processing performed the predetermined number of times.

In this embodiment, when the abnormality determiner 124 only once determines that a camera misalignment has occurred, the determination that a camera misalignment has occurred is taken as definitive, and thereby a camera misalignment is detected. This, however, is not meant as any limitation. Instead, when the abnormality determiner 124 determines that a camera misalignment has occurred, re-determination may be performed at least once so that, when it is once again determined, as a result of the re-determination, that a camera misalignment has occurred, the determination that a camera misalignment has occurred is taken as definitive.

It is preferable that, when a camera misalignment is detected, the abnormality detection device 1 perform processing for alerting the driver or the like to the detection of the camera misalignment. It is preferable that the abnormality detection device 1 perform processing for notifying the occurrence of a camera misalignment to a driving assisting device that assists driving by using information from the vehicle-mounted cameras 21 to 24. In this embodiment, where the four vehicle-mounted cameras 21 to 24 are provided, it is preferable that such alerting and notifying processing be performed when a camera misalignment has occurred in any one of the four vehicle-mounted cameras 21 to 24.

### 2-2. Exclusion Processing in Abnormality Detection Device

Next, a description will be given of the exclusion processing performed by the movement information estimator 122. In performing the processing to detect camera misalignments in the vehicle-mounted cameras 21 to 24, the abnormality detection device 1 performs the exclusion processing by means of the movement information estimator 122 as necessary. In this embodiment, the movement information estimator 122 judges whether or not optical flows derived by the flow deriver 121 include an optical flow arising from the shadow of the vehicle 7, and when an optical flow arising from the shadow of the vehicle 7 is included in the optical flows, the movement information estimator 122 estimates the first movement information after performing the exclusion processing to exclude the optical flow arising from the shadow of the vehicle 7. The same exclusion processing is performed on each of the vehicle-mounted cameras 21 to 24, and thus, here, too, for avoidance of overlapping description, the exclusion processing will be described with respect to the front camera 21 as a representative.

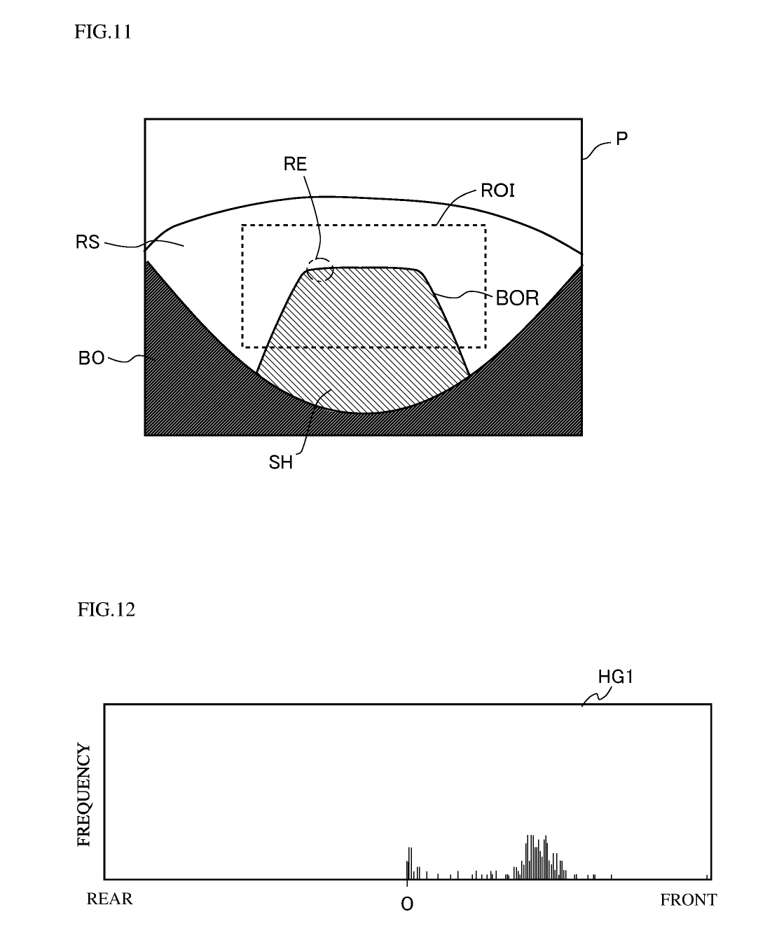

FIG. 11 is a schematic diagram illustrating a taken image P taken by the front camera 21. As shown in FIG. 11, in the taken image P, a shadow SH (hereinafter referred to as vehicle shadow SH) of the vehicle 7 itself, on which the front camera 21 is mounted, shows within the ROI. For example, it is known that, at a border position BOR of the vehicle shadow SH, for example, a feature point is detected for which an optical flow has a magnitude that equals zero or is close to zero, though the vehicle 7 is moving.

FIG. 12 is a diagram showing a first histogram HG1 generated based on the taken image P shown in FIG. 11. The first histogram HG1 is generated based on optical flows detected within the ROI. In the first histogram HG1 shown in FIG. 12, the presence of the vehicle shadow SH causes a peak to appear in a class near zero on the movement-distance axis. That is, in the first histogram HG1 shown in FIG. 12, a peak corresponding to the actual movement distance of the vehicle 7 and another peak due to the vehicle shadow SH appear, and as a result, the first movement information estimated based on the first histogram HG1 becomes inaccurate. This can be prevented by generating a histogram after excluding an optical flow the magnitude of which equals zero or is close to zero in a case where such an optical flow is detected, though the vehicle 7 is moving.

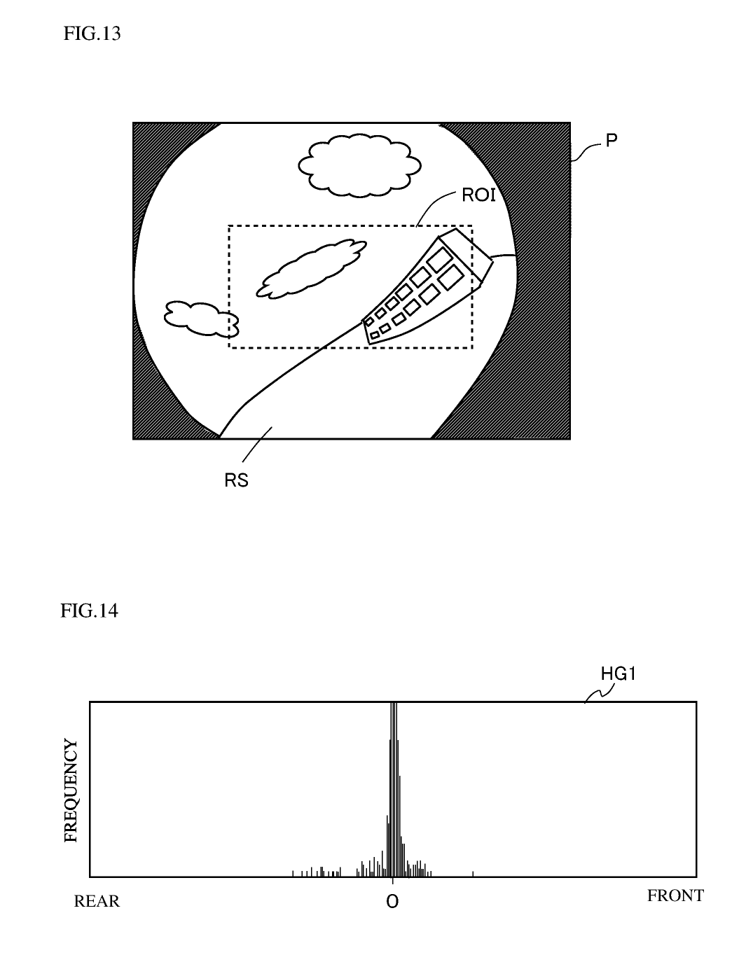

FIG. 13 is a schematic diagram illustrating a taken image P taken by the front camera 21 in which a large camera misalignment has occurred. In the example shown in FIG. 13, the front camera 21 is misaligned so much that mainly the sky and a remote building (three-dimensional object) show inside the ROI. Usually, feature points are acquired from the sky and the remote three-dimensional object as well.

FIG. 14 is a diagram illustrating a first histogram HG1 generated based on the taken image P shown in FIG. 13. As shown in FIG. 14, the optical flows of the feature points acquired from the sky and the remote three-dimensional object each have a magnitude that equals zero or is close to zero, though the vehicle 7 is moving. Accordingly, in a case where optical flows are detected that each have a magnitude that equals zero or is close to zero, if a histogram is generated by simply excluding such optical flows, it is likely that a camera misalignment where a great misalignment has occurred in a camera cannot be detected. With this in mind, in this embodiment, it is only in a case of a particular condition that the determination processing for camera misalignments is performed after performing processing for excluding an optical flow having a magnitude equal to zero or close to zero.

Specifically, in a case where the amount of optical flows having magnitudes that can be regarded as zero is equal to or less than a predetermined amount, the movement information estimator 122 estimates the first movement information after performing the exclusion processing for excluding the optical flows the magnitudes of which can be regarded as zero. More specifically, when the amount of optical flows having magnitudes that can be regarded as zero is equal to or less than the predetermined amount, the movement information estimator 122 regards the optical flows the magnitudes of which can be regarded as zero as optical flows arising from the vehicle shadow, and estimates the first movement information by performing the exclusion processing for excluding the optical flows. Optical flows the magnitudes of which can be regarded as zero may be only those the magnitudes of which equal zero, but it is preferable that optical flows the magnitudes of which can be regarded as zero include those the magnitudes of which equal zero and those the magnitudes of which are close to zero. In other words, it is preferable that optical flows the magnitudes of which can be regarded as zero are optical flows having magnitudes within a predetermined range including the magnitude of zero. The predetermined amount here is a value with which the amount of optical flows can be compared, and may be, for example, a predetermined number, a predetermined rate, etc.

Whether or not the magnitude of an optical flow can be regarded as zero is determined by use of the first optical flow OF1 or the second optical flow OF2. By detecting an optical flow the magnitude of which can be regarded as zero by using only one of the first optical flow OF1 and the second optical flow OF2, it is possible to reduce the load of processing.

In this embodiment, a determination on whether or not the magnitude of an optical flow can be regarded as zero is made by use of the first optical flow OF1. With this configuration, it is possible to find the second optical flow OF2 by performing coordinate conversion after the exclusion processing for excluding first optical flows OF1 the magnitudes of which can be regarded as zero. This makes it possible to reduce the number of first optical flows OF1 to be subjected to the coordinate conversion, and thus to reduce the load of processing. The magnitude of the second optical flow OF2 is more liable, than that of the first optical flow OF1, to be increased by a slight movement, and thus is more prone to variation for a remote feature point. Thus, by using the first optical flow OF1 in the same fashion as it is used in this embodiment, it is possible to accurately find whether or not the magnitude of an optical flow is zero.

When the sum of the value obtained by squaring the left-right component of an optical flow and the value obtained by squaring the front-rear component of the optical flow is equal to or less than a predetermined value, the magnitude of the optical flow is regarded as zero. With this configuration, it is possible to find whether the magnitude of an optical flow can be regarded as zero through the simple calculation. In this embodiment, the first optical flow OF1 is used to find the sum of the value obtained by squaring the front-rear component and the value obtained by squaring the left-right component. The predetermined value is appropriately set through an experiment, a simulation, etc. Here, whether or not the magnitude of an optical flow is zero may be found based on, for example, a value of the square root of the sum of the value obtained by squaring the front-rear component of the optical flow and the value obtained by squaring the left-right component of the optical flow.

FIG. 15 is a diagram for illustrating a method for determining the predetermined amount to be used for determining whether or not to perform the exclusion processing. FIG. 15 is a schematic diagram showing, in an enlarged manner, the region RE encircled by the dash-dot line in FIG. 11. As shown in FIG. 15, inside the ROI (predetermined region), a plurality of blocks BL are set. The size (width×height) of each block BL, which is not particularly limited, is 4 dots×4 dots, for example. That is, one block BL includes, for example, 16 pixels.

The blocks BL are each set as a unit for extracting a feature point FP. That is, a maximum of one feature point FP is extracted from each block BL. There is a case where the flow deriver 121 does not extract feature points FP from some of the blocks BL, but it does not extract two or more feature points FP from any of the blocks BL. The flow deriver 121, when it has detected two or more feature points in one block BL, extracts one feature point FP having the highest feature degree of all. With this configuration, it is possible to avoid unnecessary increase of feature points FP and thus to reduce the processing load on the controller 12.

Optical flows having magnitude that can be regarded as zero are likely to appear near the border position BOR of the vehicle shadow SH (the periphery of the vehicle shadow SH). For example, the size (width×length) of the ROI is set to be 320 dots×128 dots, and the block size (width×length) is set to be 4 dots×4 dots. In this case, when feature points FP arise from the vehicle shadow SH to be laterally aligned, the number of such feature points FP is 80 (=320/4). Even at a larger estimation, the number of feature points FP arising from the vehicle shadow SH is estimated at 160 (=80×2) at most. That is, even when the vehicle shadow SH is present in the ROI, it is estimated that the number of optical flows the magnitudes of which can be regarded as zero does not exceed 160. On the other hand, as is clear from FIG. 14, if the camera 21 is misaligned so much that the sky and the remote three-dimensional object show in the taken image, it is conceivable that the number of optical flows the magnitudes of which can be regarded as zero will be much larger than 160.

Accordingly, in the above example, if the number of optical flows the magnitudes of which can be regarded as zero is equal to or smaller than 160, it is conceivable that the optical flows the magnitudes of which can be regarded as zero arise from the vehicle shade SH and thus is inappropriate as a basis for camera misalignment determination. Thus, it is possible to make a correct determination on camera misalignment by calculating the first movement information with optical flows the magnitudes of which can be regarded as zero excluded from optical flows acquired by the flow deriver 121.

As described above, the predetermined amount can be found based on the size of the ROI and the size of the block BL. Here, in the above example, “2” is used as a coefficient in the calculation for the larger estimation of the number of feature points FP arising from the vehicle shadow SH, but this is merely an example. The coefficient may be changed appropriately according to the shape and so forth of the vehicle 7, for example. For example, different coefficients may be used depending on whether the shadow generated by the shape of the vehicle 7 has a linear shape or a convex shape. For example, in the latter case, the border line (the border position BOR) is longer, and thus a larger coefficient may be used, than in the former case. In other words, the predetermined amount may be calculated based on the size of the ROI, the size of the block BL, and the vehicle shape.

According to this embodiment, only in a case where it can be judged that an optical flow the magnitude of which can be recognized as zero arises from the vehicle shadow SH, a histogram can be generated with such an optical flow excluded. With this configuration, it is possible to enhance the accuracy of the estimation of the first movement information, and thus to correctly perform the processing for camera misalignment determination.

In this embodiment, the movement information estimator 122 is configured to always perform the exclusion processing when the amount of optical flows the magnitudes of which can be recognized as zero is equal to or less than the predetermined amount, to exclude such optical flows, but this is merely an example. For example, the movement information estimator 122 may be configured to estimate the first movement information without performing the above-described exclusion processing when the speed of the vehicle 7 is lower than a predetermined speed threshold value. The predetermined speed threshold value may be, for example, equal to or lower than 1 km per hour. With this configuration, it is possible, in a case where the vehicle 7 is traveling at a low speed, to prevent degradation of the accuracy of the estimation of the first movement information resulting from excessive exclusion of optical flows.

In this embodiment, the movement information estimator 122 estimates the first movement information without performing the exclusion processing in a case where the amount of optical flows the magnitude of which can be regarded as zero exceeds the predetermined amount. The first movement information obtained as the estimated value is used for comparison with the second movement information, and thereby, camera misalignment determination is performed. According to this embodiment, it is possible to estimate the first movement information with enhanced accuracy and also to detect a camera misalignment where a great misalignment has occurred in a camera. If the amount of optical flows the magnitudes of which can be regarded as zero exceeds the predetermined amount, it indicates that it is highly likely that a great misalignment of the camera 21 has occurred. In this embodiment, even in such a case, the camera misalignment determination is performed by comparing the first movement information and the second movement information with each other, and thus it is possible to reduce the likelihood of an erroneous determination.

Here, the abnormality determiner 124 may detect an abnormality of the camera 21 when the amount of optical flows the magnitudes of which can be regarded as zero exceeds the predetermined amount. That is, if the amount of optical flows the magnitudes of which can be regarded as zero exceeds the predetermined amount, the misalignment of the camera 21 may be detected without estimating the first movement information. This contributes to quick detection of a great misalignment of the camera 21. In this embodiment, a judgment is made on whether or not optical flows arising from the shade of the vehicle 7 are present based on whether or not the amount of optical flows the magnitudes of which can be regarded as zero exceeds the predetermined amount, but the judgment may be made by means of other methods. For example, the following method is possible. The border position of the vehicle shadow is detected (the method for the detection will be described later in a first modified example), and if the amount of optical flows generated based on feature points located at the border position or close to the border position is equal to or more than a predetermined amount, it is judged that optical flows arising from the vehicle shade are present, and such optical flows are excluded from the estimation of the first movement information.

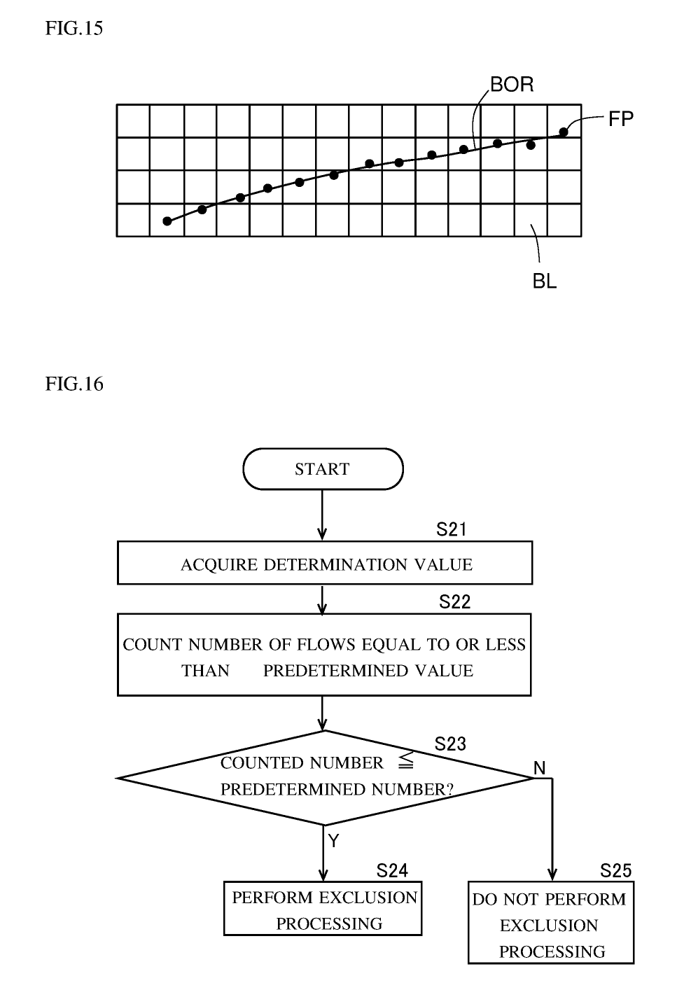

FIG. 16 is a flow chart showing an example of procedure for determining whether or not to perform the exclusion processing. In this embodiment, the processing for making a determination on whether or not to perform the exclusion processing is started at a time point when a first optical flow OF1 is obtained by the flow deriver 121. First, the movement information estimator 122 acquires a determination value with which to make a determination on whether or not the magnitude of the first optical flow OF1 is zero (step S21). The determination value is, as described above, the sum of the value obtained by squaring the front-rear component of the first optical flow OF1 and the value obtained by squaring the left-right component of the first optical flow OF1. The determination value is acquired for each first optical flow OF1.

The movement information estimator 122 counts the number of first optical flows OF1 the determination value for which is equal to or less than the predetermined value (step S22). That is, the number of first optical flows OF1 the magnitudes of which can be regarded as zero is counted.

The movement information estimator 122 checks whether or not the number of the first optical flows OF1 counted in step S22 is equal to or less than a predetermined number (step S23). That is, it is checked whether or not the number of the first optical flows OF1 the magnitudes of which can be regarded as zero is equal to or less than the predetermined number. It is preferable that the predetermined number be, as described above, acquired based on the size of the ROI, the size of the block BL, and the shape of the vehicle 7.

When the number of the first optical flows OF1 the magnitudes of which can be regarded as zero is equal to or less than the predetermined number (Yes in step S23), the movement information estimator 122 performs the exclusion processing (step S24). Here, “when the number of the first optical flows OF1 the magnitudes of which can be regarded as zero is equal to or less than the predetermined number” includes a case where there is no such first optical flow OF1 as has a magnitude that can be regarded as zero.

Specifically, the movement information estimator 122 excludes, from the plurality of first optical flows OF1 derived by the flow deriver 121, the first optical flows OF1 the magnitudes of which can be regarded as zero, that is, the first optical flows OF1 arising from the shadow of the vehicle 7. In response to this performance of the exclusion processing, the flow deriver 121 finds a second optical flow OF2 for each of the first optical flows OF1 remaining after the exclusion. The movement information estimator 122 generates the histograms HG1 and HG2 based on the thereby acquired plurality of second optical flows OF2, and thereby estimates the first movement information (in this embodiment, movement distance). Based on the thus estimated first movement information, camera misalignment determination is performed. In the misalignment determination, a camera misalignment may or may not be detected.

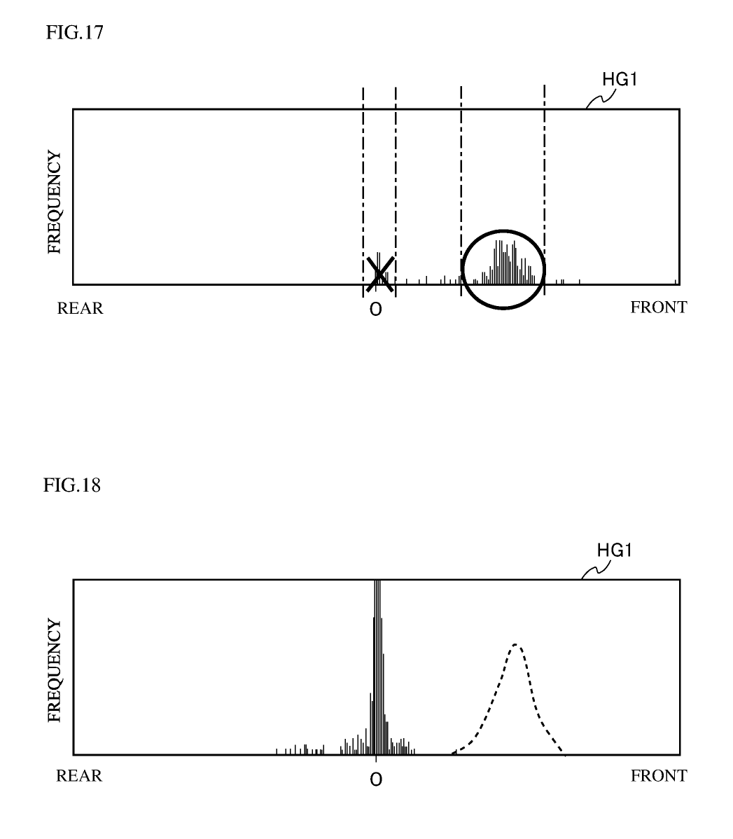

FIG. 17 is a schematic diagram for illustrating a histogram obtained in a case where the exclusion processing has been performed. Shown in FIG. 17 is a first histogram HG1 obtained based on the front-rear component. In the example shown in FIG. 17, there have been generated optical flows that arise from the vehicle shadow SH and the magnitudes of which can be regarded as zero.

As shown in FIG. 17, in a case where the exclusion processing is performed to exclude optical flows magnitudes of which can be regarded as zero, the optical flows the movement distances of which in the front-rear direction equal zero or are close to zero are excluded, and they are not used for the estimation of the movement distance in the front-rear direction. The movement information estimator 122 estimates the movement distance in the front-rear direction by using the optical flows remaining after the exclusion processing.

Here, also in a case where the movement distance in the left-right direction is estimated by using the second histogram HG2, the movement distance is estimated after excluding optical flows magnitudes of which can be regarded as zero. The movement information estimator 122 may estimate the first movement information by using all the optical flows remaining after the exclusion processing, or may estimate the first movement information by further excluding some more of the optical flows. For example, the movement information estimator 122 may be configured to estimate the movement distance by narrowing down to such optical flows as indicate movement distances in a certain range set based on the second movement information (for example, a certain range around the second movement information). In the example shown in FIG. 17, the movement distance in the front-rear direction is estimated based on optical flows having movement distances in the front-rear direction within a certain range.

Referring back to FIG. 16, when the number of first optical flows the magnitudes of which can be regarded as zero exceeds the predetermined number (No in step S23), the movement information estimator 122 does not perform the exclusion processing (step S25). In this case, all the first optical flows OF1 derived by the flow deriver 121 are converted to second optical flows OF2. The movement information estimator 122 estimates the first movement information based on the thus acquired second optical flows OF2.

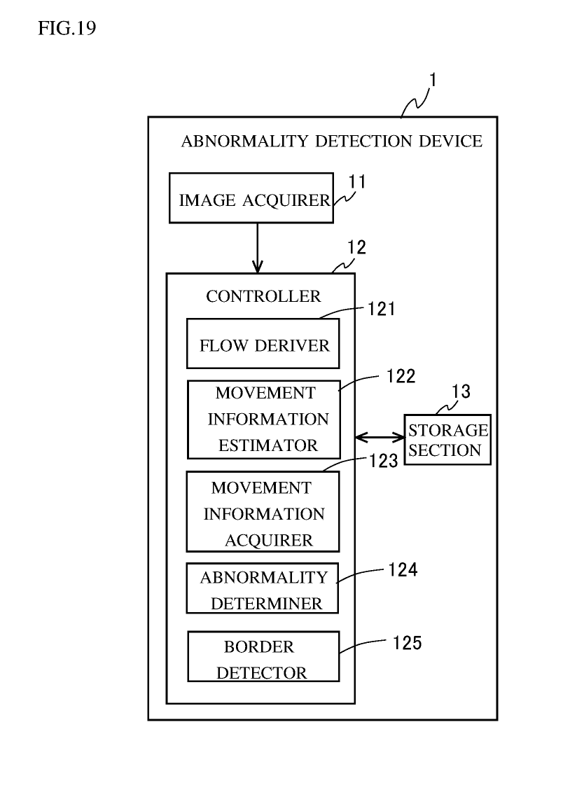

FIG. 18 is a schematic diagram for illustrating a histogram obtained when the exclusion processing is not performed. Shown in FIG. 18 is a first histogram HG1 obtained based on the front-rear component. When the exclusion processing is not performed, a large number of optical flows are generated to have magnitudes that can be regarded as zero, and thus, as shown in FIG. 18, a peak appears at zero, or close to zero, on the axis of the movement distance in the front-rear direction. This greatly deviates from the actual distribution of movement distances (indicated by a broken line), and the movement distance in the front-rear direction estimated from the histogram HG1 shown in FIG. 18 significantly differs from the movement distance acquired as the second movement information. Thus, a misalignment of the camera 21 is detected. The camera misalignment detected here is a great deviation in the installation position of the camera 21.

### 3. Modified Example, Etc.

### 3-1. First Modified Example

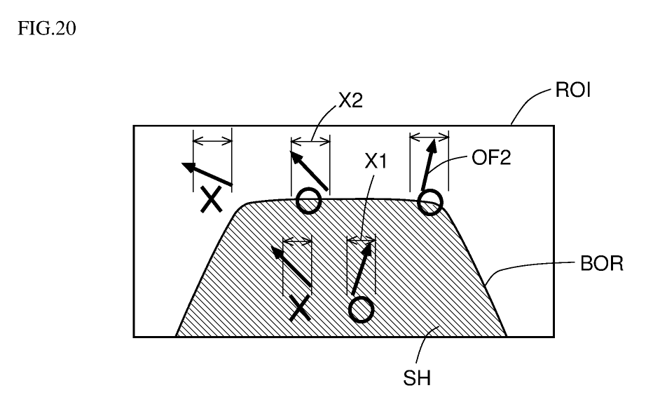

FIG. 19 is a block diagram showing a configuration of an abnormality detection device 1 according to a first modified example. According to the modified example, the abnormality detection device 1 further includes a border detector 125. The border detector 125 detects the border position BOR of the vehicle shadow SH of the vehicle 7 in images taken by the cameras 21 to 24. The border detector 125 detects the border position of the vehicle shadow SH. At the border position of the vehicle shadow SH, pixel values in the images taken by the cameras 21 to 24 vary sharply. Accordingly, for example, by performing differentiation processing on the pixel values in the images taken by cameras 21 to 24, it is possible to detect the border position BOR of the vehicle shade SH. The detection of the border position of the vehicle shadow SH may be performed by using, for example, an edge detection method such as the Sobel method, Canny method, or the like. The border detector 125 may be included in the movement information estimation device 10.

In this modified example, the movement information estimator 122 performs, in addition to the exclusion processing described in the above embodiment, processing for excluding at least either optical flows on the border position BOR or optical flows crossing the border position BOR, and estimates the first movement information. In this modified example, the movement information estimator 122 estimates the first movement information after excluding both the optical flows on the border position BOR and the optical flows crossing the border position BOR.

The processing for excluding the optical flows on the border position BOR and the optical flows crossing the border position BOR may be performed at whichever of a time point when the first optical flows OF1 are derived and a time point when the second optical flows OF2 are derived. However, the former time point is preferable in view of the reduction of the load of processing. In the case of the latter time point, it is necessary to find the border position in the world coordinate system.

In this modified example, too, in the estimation of the first movement information, such optical flows as arise from the vehicle shadow SH and have magnitudes that can be regarded as zero are excluded. Further, in this modified example, in the estimation of the first movement information, processing is performed to exclude such optical flows as are derived from near the border position BOR of the vehicle shadow SH even if their magnitudes are not zero. According to this modified example, it is possible to estimate the first movement information after excluding such optical flows as are acquired from near the border position BOR of the vehicle shadow SH and less reliable, it is possible to improve the reliability of the camera alignment determination processing.

### 3-2. Second Modified Example

In a second modified example, too, the abnormality detection device 1 includes the border detector 125 which detects the border position of the vehicle shadow SH of the vehicle 7 in images taken by the cameras 21 to 24. In the second modified example, the movement information estimator 122 estimates the first movement information after performing, in addition to the exclusion processing described in the above embodiment, processing for excluding some of a plurality of optical flows based on a predetermined threshold value.

Specifically, the movement information estimator 122 excludes, from among a plurality of second optical flows OF2, such second optical flows OF2 as have movement distances in the left-right direction that exceed the predetermined threshold value, to generate histograms HG1 and HG2, and then estimates the first movement information. In this modified embodiment, too, images taken when the vehicle 7 is traveling straight are used to estimate the first movement information. Thus, the movement distance in the left-right direction is ideally zero, and presumably, the second optical flows OF2 the movement distances of which in the left-right direction exceed the threshold value are less reliable. With this modified example, by excluding these second optical flows OF2 that are less reliable, it is possible to improve the accuracy of the estimated value of the first movement information.

In this configuration, according to this modified example, the predetermined threshold value described above differs between the inside and the outside of the vehicle shadow SH determined based on the border position BOR. FIG. 20 is a schematic diagram for illustrating an abnormality detection device 1 according to the second modified example. FIG. 20 shows a state where the vehicle shadow SH shows in the ROI set in images taken by the cameras 21 to 24. Note that FIG. 20 is an image obtained after the conversion to the world coordinates.

As shown in FIG. 20, inside the border position BOR of the vehicle shadow SH (that is, in the shadow), the threshold value is set at X1. Outside the border position BOR of the vehicle shadow SH (that is, out of the shadow), the predetermined threshold value is set at X2. X1 is set to be smaller than X2. That is, the exclusion of second optical flows OF2 is more readily performed inside the vehicle shadow SH than outside the vehicle shadow SH. Less reliable second optical flows OF2 are more frequently acquired inside the vehicle shadow SH, and thus, according to the configuration of this modified example, it is possible to further improve the accuracy of the estimated value of the first movement information.

### 3-3. Points to Note

The configurations of the embodiments and modified examples specifically described herein are merely illustrative of the present invention. The configurations of the embodiments and modified examples can be modified as necessary without departure from the technical idea of the present invention. Two or more of the embodiments and modified examples can be implemented in any possible combination.

The above description deals with configurations where the data used for the determination of an abnormality in the vehicle-mounted cameras 21 to 24 is collected when the vehicle 7 is traveling straight. This, however, is merely illustrative; instead, the data used for the determination of an abnormality in the vehicle-mounted cameras 21 to 24 may be collected when the vehicle 7 is not traveling straight. By use of the speed information obtained from the vehicle speed sensor 41 and the information obtained from the steering angle sensor 42, the actual movement distances of the vehicle 7 in the front-rear and left-right directions can be found accurately; it is thus possible to perform the abnormality determination as described above even when the vehicle 7 is not traveling straight.

What is claimed is:

1. A movement information estimation device that estimates movement information on a mobile body based on information from a camera mounted on the mobile body, the movement information estimation device comprising:
a flow deriver configured to derive an optical flow for each feature point based on an image taken by the camera; and
a movement information estimator configured to estimate movement information on the mobile body based on optical flows derived by the flow deriver,
wherein
the movement information estimator is configured to estimate movement information on the mobile body after performing exclusion processing for excluding an optical flow arising from a shadow of the mobile body.

2. An abnormality detection device that detects an abnormality in a camera mounted on a mobile body, the abnormality detection device comprising:
a flow deriver configured to derive an optical flow for each feature point, based on an image taken by the camera;
a movement information estimator configured to estimate first movement information on the mobile body based on optical flows derived by the flow deriver;
a movement information acquirer configured to acquire second movement information on the mobile body, the second movement information being a target of comparison with the first movement information; and
an abnormality determiner configured to determine an abnormality in the camera based on the first movement information and the second movement information,
wherein
the movement information estimator is configured to estimate the first movement information after performing exclusion processing for excluding an optical flow arising from a shadow of the mobile body.

3. The abnormality detection device according to claim 2,
wherein
the movement information estimator is configured to perform, when an amount of the optical flow a magnitude of which can be regarded as zero is equal to or less than a predetermined amount, the exclusion processing by regarding the optical flow the magnitude of which can be regarded as zero as the optical flow arising from the shadow of the mobile body.

4. The abnormality detection device according to claim 3,
wherein,
the movement information estimator is configured to estimate the first movement information without performing the exclusion processing when the amount of the optical flow the magnitude of which can be regarded as zero exceeds the predetermined amount.

5. The abnormality detection device according to claim 3,
wherein,
the abnormality determiner is configured to detect an abnormality in the camera when the amount of the optical flow the magnitude of which can be regarded as zero exceeds the predetermined amount.

6. The abnormality detection device according to claim 2,
wherein,
the movement information estimator is configured to estimate the first movement information without performing the exclusion processing when a speed of the mobile body is lower than a predetermined speed threshold value.

7. The abnormality detection device according to claim 2,
wherein
the feature point is extracted from inside a predetermined region in an image taken by the camera,
a plurality of blocks are set inside the predetermined region, and
a maximum of one feature point is extracted from each of the blocks.

8. The abnormality detection device according to claim 3,
wherein
each of the optical flows derived by the flow deriver includes
a first optical flow acquired from an image taken by the camera and
a second optical flow acquired by subjecting the first optical flow to coordinate conversion, and
whether or not the magnitude of the optical flow can be regarded as zero is determined by use of the first optical flow or the second optical flow.

9. The abnormality detection device according to claim 3,
wherein,
when a sum of a value obtained by squaring a front-rear component of the optical flow and a value obtained by squaring a left-right component of the optical flow is equal to or less than a predetermined value, the magnitude of the optical flow is regarded as zero.

10. The abnormality detection device according to claim 2, further comprising a border detector configured to detect a border position of a shadow of the mobile body in an image taken by the camera,
wherein
the movement information estimator is configured to estimate the first movement information after performing, in addition to the exclusion processing, processing for excluding at least either the optical flow on the border position or the optical flow crossing the border position.

11. The abnormality detection device according to claim 2, further comprising a border detector configured to detect a border position of a shadow of the mobile body in an image taken by the camera,
wherein
the movement information estimator is configured to estimate the first movement information after performing, in addition to the exclusion processing, processing for excluding part of optical flows based on a predetermined threshold value, and
the predetermined threshold value differs between inside and outside the shadow determined based on the border position.

12. The abnormality detection device according to claim 2,
wherein
the movement information acquirer is configured to acquire the second movement information based on information obtained from a sensor other than the camera provided on the mobile body.

13. The abnormality detection device according to claim 2,
wherein
the abnormality is a state where a misalignment has occurred in installation of the camera.

14. An abnormality detection method for detecting an abnormality in a camera mounted on a mobile body, the method comprising:
a flow deriving step of deriving an optical flow for each feature point based on an image taken by the camera;
a movement-information estimating step of estimating first movement information on the mobile body based on optical flows derived in the flow deriving step;
a movement-information acquiring step of acquiring second movement information on the mobile body as a target for comparison with the first movement information; and
an abnormality determining step of determining an abnormality in the camera based on the first movement information and the second movement information,
wherein
estimation of the first movement information is performed after performing exclusion processing for excluding an optical flow arising from a shadow of the mobile body.

15. The abnormality detection method according to claim 14,
wherein,
when an amount of the optical flow a magnitude of which can be regarded as zero is equal to or less than a predetermined amount, the exclusion processing is performed by regarding the optical flow the magnitude of which can be regarded as zero as the optical flow arising from the shadow of the mobile body.
